(19) United States
(12) Patent Application Publication
(10) Pub. No.: US 2006/0289290 A1
(43) Pub. Date: Dec. 28, 2006

(54) Electrolytic cell effluent treatment method and device for the production of aluminium

(76) Inventors: Guillaume Girault, La Chambre (FR); Elisabeth Couzinie, St. Jean de Maurienne (FR); Claude Vanvoren, St. Jean de Maurienne (FR)

Correspondence Address: DENNISON, SCHULTZ & MACDONALD, 1727 KING STREET, SUITE 105, ALEXANDRIA, VA, 22314, US

(21) Appl. No.: 10/535,820

(22) PCT Filed: Dec. 15, 2003
(86) PCT No.: PCT/FR03/03721

§ 371 Date: Aug. 17, 2005

(30) Foreign Application Priority Data
Dec. 18, 2002 (FR) 02/16073

(51) Int. Cl. B01D 53/00

(52) U.S. Cl. 204/157.3

(57) ABSTRACT

The invention relates to a process and an installation for the treatment of gaseous effluents produced by at least one electrolytic cell (1) in which the effluents are conveyed by at least one conveyance duct (11) to treatment means (12-19) comprising at least one reactor (12) to extract fluorinated products contained in effluents by reaction with powder alumina (16) and a separation device (13) to separate the alumina output from the reactor (12) from the residual gas fraction and comprising filter means (14). According to the invention, the effluents are cooled before being treated by the injection of droplets of a cooling fluid into the conveyance duct(s) (11) at at least one point (P) located upstream of the reactor (12), and by vaporisation of the said fluid. The invention provides an efficient means of cooling effluents from electrolytic cells without affecting their operation.

### DOMAIN OF THE INVENTION

The invention relates to aluminium production by igneous electrolysis using the Hall-Héroult process. It is more particularly related to the treatment of gaseous effluents produced by electrolytic cells.

### STATE OF THE ART

Aluminium metal is produced industrially by igneous electrolysis, namely by electrolysis of alumina in solution in a molten cryolite bath called an electrolyte bath using the well-known Hall-Héroult process. Electrolytic reactions, secondary reactions and high operating temperatures lead to the production of gaseous effluents that in particular contain carbon dioxide, fluorinated products and dust (alumina, electrolyte bath, etc.).

Release of these effluents into the atmosphere is severely controlled and regulated, not only concerning the ambient atmosphere in the electrolysis room, for the safety of personnel operating close to the electrolytic cells, but also for atmospheric pollution. Pollution regulations in many countries impose limits on effluent quantities released into the atmosphere.

There are now solutions for confining, collecting and treating these effluents reliably and satisfactorily. In the most modern plants, effluents are confined by a hooding, captured by suction and treated in a chemical treatment installation so as to recover fluorinated gases by reaction with “fresh” powder alumina, in other words alumina containing little or no fluorinated products. The fluorinated gases are adsorbed on the alumina. The alumina and dust derived from electrolytic cells are then separated from the residual gas and are partly or completely re-used to supply electrolytic cells. The alumina circulation flow in the treatment installation is usually continuous.

Effluent treatment installations typically comprise one or several reactors, in which the effluents are brought into contact with powder alumina so as to make them react with the alumina, and filters to separate alumina from the residual gas. Some of the alumina separated from the residual gas may be put back into the reactor in order to increase the treatment efficiency.

Treatment installations typically comprise a bank of treatment units in parallel, each unit comprising a reactor and a filtration chamber comprising filtration means (typically pockets or filtering bags) and a fluidised bottom hopper. French patent application FR 2 692 497 (corresponding to Australian patent AU 4 007 193) taken out by the Procédair Company divulges a treatment unit in which the reactor and the filters are integrated in a common chamber.

For cost effectiveness reasons of a plant, aluminium producers attempt to obtain the highest possible electrolysis current intensities while maintaining or even improving operating conditions of the electrolytic cells. However, the increase in intensity does increase the flow of effluents and their temperature. A high effluent temperature can cause degradation of effluent treatment performances, or even a degradation of treatment installations, particularly typically used filter fabrics made of a polymer material.

The effluent temperature may be lowered by dilution in ambient air upstream of treatment installations. However, this type of solution causes a large increase in the total volume flow of gases to be treated, which requires a significant increase in the size of treatment installations required to maintain the effluent treatment flow originating from electrolytic cells, which is the useful flow from the installation. This increase in the size of the treatment installations increases investment and operating costs. Cooling of effluents by dilution in ambient air also has the disadvantage of being sensitive to the ambient air temperature.

Therefore, the applicant attempted to find industrially acceptable and economic means of treating hot electrolytic cell effluents, in other words at effluent temperatures typically greater than about 120° C.

### DESCRIPTION OF THE INVENTION

The purpose of the invention is a process for the treatment of gaseous effluents produced by an igneous electrolysis aluminium production cell comprising cooling of effluents upstream of the treatment means.

More precisely, the purpose of the invention is a process for treatment of gaseous effluents produced by an igneous electrolysis aluminium production cell in which effluents are conveyed by at least one duct to the treatment means comprising at least one reactor and a separation device, and the effluents and powder alumina are introduced into the reactor so as to make the fluorinated products contained in the effluents react with alumina, and the alumina is separated from the residual gas using the separation device, the process being characterised in that droplets of a cooling fluid are injected into the effluent conveyance duct, or at least one of the effluent conveyance ducts, upstream of the treatment means.

Another purpose of the invention is an installation for the treatment of the gaseous effluents produced by an igneous electrolysis aluminium production cell comprising at least one conveyance duct for the said effluents, at least one reactor and a separation device, and characterised in that it also comprises a device for injection of droplets of a cooling fluid into the conveyance duct or at least one of the conveyance ducts.

The effluents are cooled by vaporisation of the said droplets. The applicant has observed that, surprisingly, it is possible to cool the effluents from an electrolytic cell in this manner efficiently, without degrading operation of the cell or the treatment installation.

The invention provides a means of increasing the mass flow, and therefore the useful flow, of a treatment installation without increasing its size. The intensity carried by the cells in a plant can be increased without needing to modify the size of the effluent treatment installations.

The invention also provides a means of reducing the size of treatment installations without reducing the “useful” intake flow at electrolytic cells or the treatment efficiency, in other words without increasing releases from roof vents in electrolysis rooms. This is particularly useful when constructing a new treatment installation and avoids the installation being oversized due to dilution of effluents by ambient air.

The invention also provides a means of increasing the intensity in electrolytic cells of a plant without needing to replace existing installations by larger installations.

Cooling of effluents also reduces their effective flow, which reduces the filtration velocity and therefore filter wear, and reduces the electrical consumption of suction fans due to a lower pressure drop which is not counterbalanced by an increase in the density.

The invention will be better understood after reading the following detailed description and the attached figures.

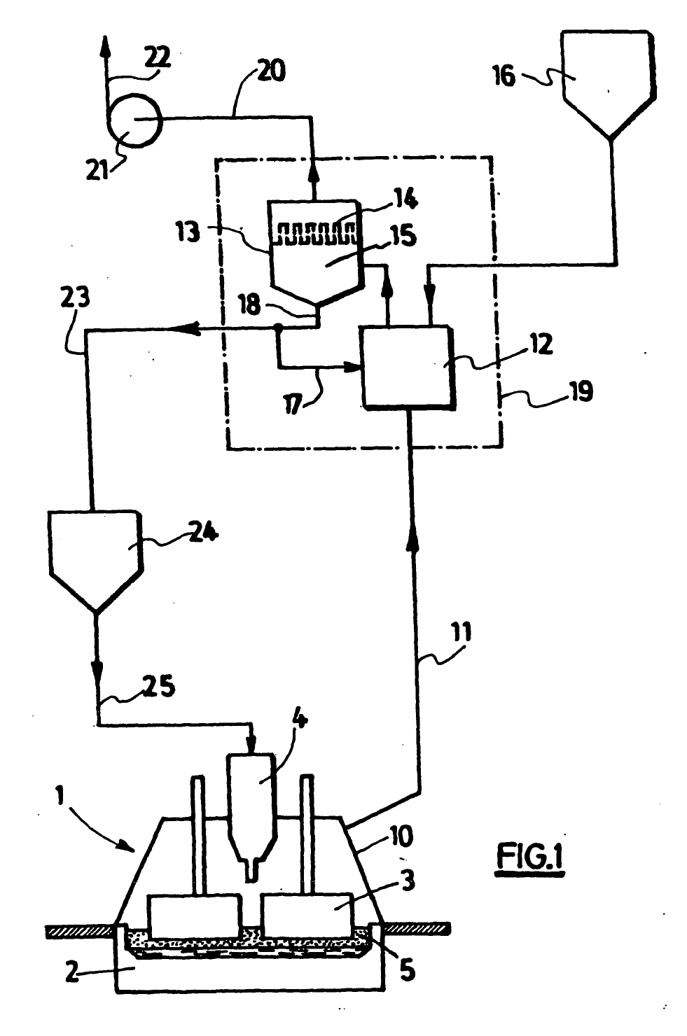

FIG. 1 diagrammatically illustrates an electrolytic cell equipped with a gaseous effluent treatment installation typical of prior art.

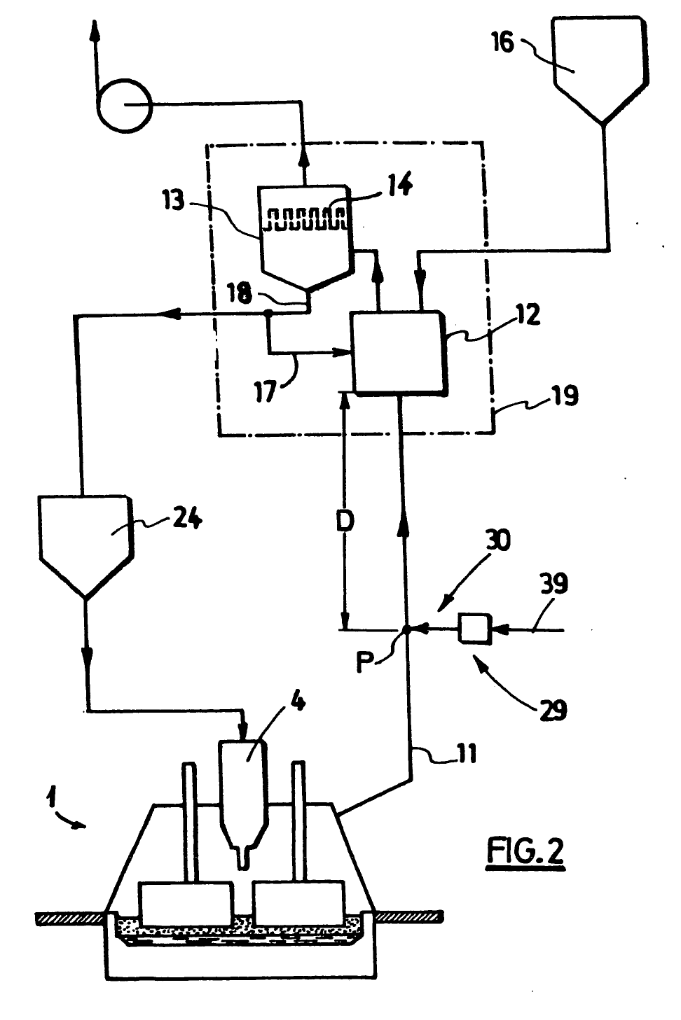

FIG. 2 diagrammatically illustrates an electrolytic cell equipped with a gaseous effluent treatment installation according to one embodiment of the invention.

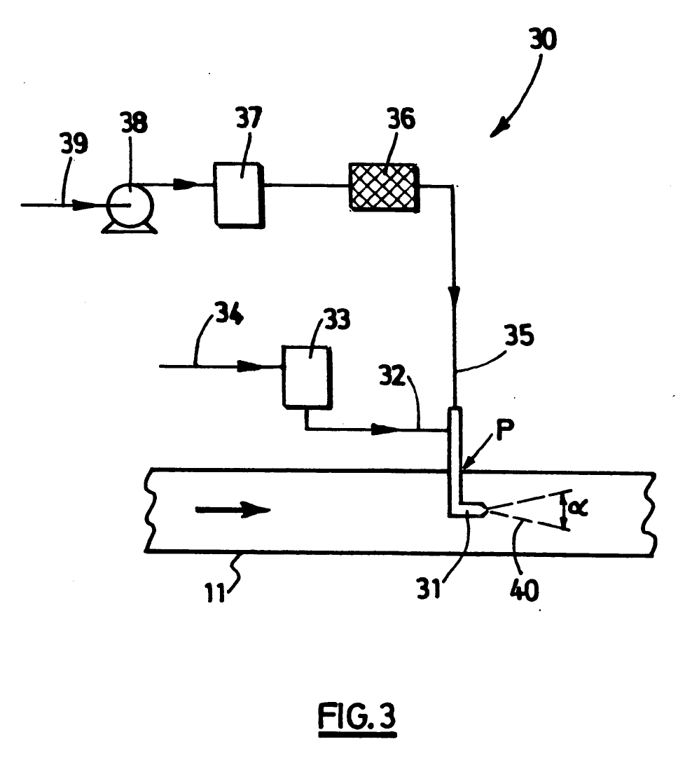

FIG. 3 diagrammatically illustrates a device for injection of cooling fluid droplets according to one embodiment of the invention.

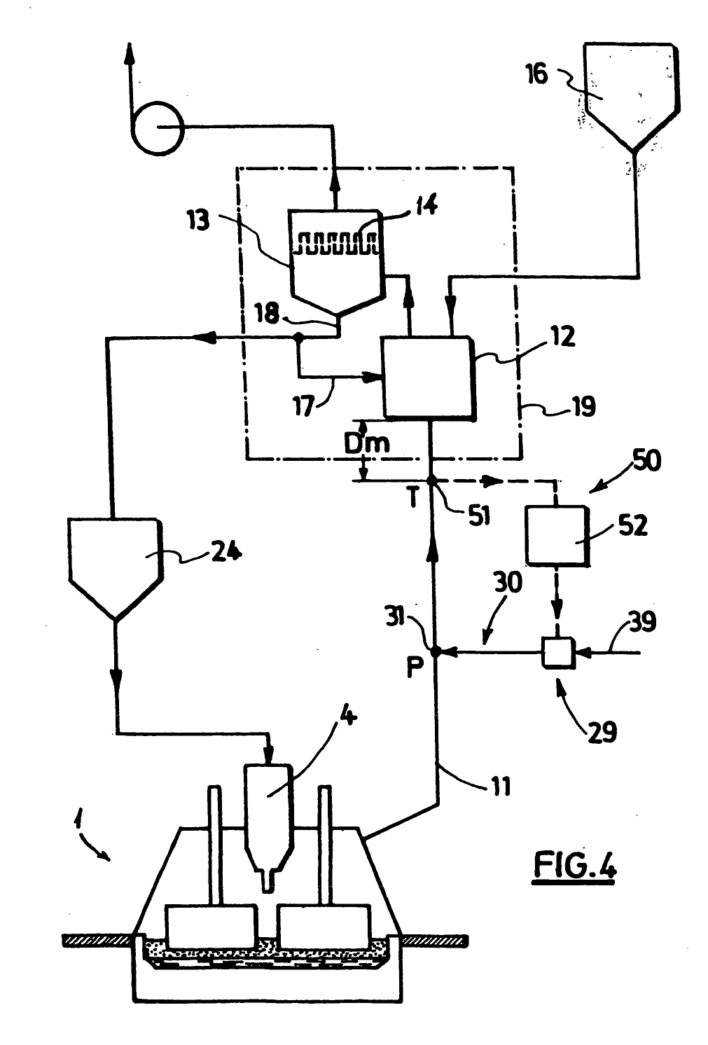

FIG. 4 diagrammatically illustrates a variant of the effluent treatment installation according to the invention.

As illustrated in FIG. 1, an igneous electrolysis aluminium production cell (1) comprises a pot (2), carbonaceous anodes (3) partially immersed in the electrolytic bath (5), and a device (4) for feeding the bath with alumina. The pot (2) is covered by a hooding (10) capable of confining gaseous effluents produced by the cell (1). The hooding (10) also usually includes hoods that are removable in whole or in part.

The effluents comprise a gaseous part (especially containing air, carbon dioxide and fluorinated products) and a solid or “dust” part (containing alumina, electrolytic bath, etc). Effluents are typically extracted from the hooding (10) by suction using one or several fans (21) located downstream of the treatment installation (12-19). They are conveyed to treatment means (12-19) through one or several ducts (11). Treatment extracts fluorinated products contained in the effluents and leaves a residual gas fraction containing a negligible quantity of fluorinated products. Therefore, the residual gas fraction is the fraction of the gaseous part of the effluents that did not react with alumina.

According to the invention, the process for treatment of gaseous effluents produced by at least one igneous electrolysis aluminium production cell (1) comprises cooling of the effluents upstream of the treatment means (12-19).

In one preferred embodiment of the invention, the process for treatment of gaseous effluents produced by at least one igneous electrolysis aluminium production cell (1) comprises:
conveying the said effluents through at least one duct (11) to the treatment means (12-19) comprising at least:
   a reactor (12) to extract the fluorinated products contained in the effluents by reaction with powder alumina (16);
   a separation device (13) to separate alumina output from the reactor(s) (12) and the residual gas fraction and comprising filtration means (14),
introducing effluents and powder alumina into the reactor(s) (12), so that the effluents will react with alumina,
separating alumina from the residual gas fraction using the separation device (13),
conveying all or some of the alumina output from the separation device (13) called “fluorinated” alumina, to one or several electrolytic cells (1),

and is characterised in that it also comprises injection of cooling fluid droplets into the conveyance duct (11) or at least one of the conveyance ducts (11) at at least one point (P) located upstream of the reactor(s)

(12), so as to cool the effluents by vaporisation of the said fluid before they are introduced into the reactor(s) (12).

The so-called “fresh” alumina used for extraction of fluorinated products from effluents may typically be taken from a silo (16).

Part (17) of the “fluorinated” alumina (18) derived from the separation operation may be put back into the reactor(s) (12) in order to increase the treatment efficiency.

All or some of the fluorinated alumina output from the separation device (13) may be conveyed directly or indirectly to the electrolytic cells (1).

The position of an injection point (P) located upstream of the reactor(s) (12) is illustrated diagrammatically in FIGS. 2 and 4. The injection points (P) are typically located upstream of the treatment system (19) containing the reactor(s) (12).

The location of the injection point(s) (P) of the cooling fluid into the conveyance ducts (11) is advantageously such that the droplets evaporate entirely before they reach the reactor(s) (12). This prevents the liquid cooling fluid from entering the reactor, which could cause problems with handling of alumina and deterioration of the filtration means. The distance D between the injection point(s) (P) and each reactor (12) necessary for complete vaporisation of the droplets is typically more than 15 m.

Also preferably, cooling fluid droplets are fully vaporised before they touch a wall close to the injection point or a first obstacle. This avoids the impact of droplets on the wall of the ducts (11) and/or fluid accumulation that could cause corrosion of the ducts. For that purpose, the droplets are advantageously injected in the effluent flow direction. For the same purpose, the cooling fluid droplets are advantageously injected in the form of a dispersion cone (or sprinkling cone) (40) with a low opening angle α typically less than about 20° (see FIG. 3). Also for the same purpose, it is preferable to form droplets with a size such that they are entirely vaporised during their route between the injection point(s) and the closest obstacle.

The droplet vaporisation time depends on the effluent temperature and the size of the droplets. The distance travelled during vaporisation of the droplets depends on the velocity of the effluents. The inventors estimate that for typical industrial installations and for temperatures of the order of 150° C., the size of droplets is preferably less than 100 μm to enable complete vaporisation of the droplets before they reach an obstacle or the reactor. The size of the droplets is typically between 1 μm and 100 μm since droplets smaller than 1 μm are difficult to produce. Very fine droplets may be obtained using nozzles supplied with a mix of cooling fluid and compressed air.

Advantageously, the process comprises heating of the cooling fluid before it is introduced in the conveyance duct(s) (11) in order to reduce the time necessary for its vaporisation. This variant also provides a means of lowering the temperature threshold (typically 120° C.) below which the droplets can no longer be fully vaporised before reaching the reactor. Heating may be achieved by contact between a cooling fluid inlet duct (35) and effluent conveyance ducts (11), or by direct contact of the cooling fluid with the conveyance ducts (11) before injection into the effluents. The cooling fluid is typically heated up to a determined temperature that is advantageously 10° to 20° below the fluid evaporation temperature.

According to one advantageous variant of the invention, effluents are circulated in a Venturi upstream of the reactor(s) (12) and some or all of the cooling fluid droplets are injected into the Venturi. In other words, the process according to the invention advantageously comprises circulation of effluents in a Venturi and at least part of the said injection of cooling fluid droplets is done in the Venturi. The turbulent movement of effluents in the Venturi improves mixing of the droplets and accelerates their vaporisation. Some of the cooling fluid droplets may possibly be injected upstream and/or downstream of the Venturi.

These various means can advantageously be combined to facilitate fast vaporisation of the droplets (injection of droplets in the effluent flow direction, formation of a sprinkling cone with a small angular opening, formation of small droplets, heating of the cooling fluid before it is introduced into the effluent flow and/or passage of effluents in a Venturi).

The droplets vaporisation rate may possibly be controlled using detectors (such as optical systems or hygrometers) close to the reactor inlet.

The necessary cooling fluid flow rate depends on the effluents temperature, the target temperature drop and the latent heat of vaporisation of the cooling fluid. When the cooling fluid is pure water, the flow rate is typically between 0.1 and 2 g of water/Nm³ of effluent/° C., and more typically between 0.2 and 1 g of water/Nm³ of effluent/° C. Thus, for example, in order to lower the temperature of a 100 Nm³/s effluent flow rate by 10° C., a cooling fluid flow rate of 0.5 g of water/Nm³ of effluent/° C. is equivalent to a total flow rate of 500 g/s.

The said droplets can advantageously be produced by pulverisation of the said fluid, typically starting from the liquid phase. This pulverisation may be done using at least one nozzle.

The droplets may be produced continuously or discontinuously.

The cooling fluid is advantageously water or a liquid containing water, since water has a very high latent heat of vaporisation. The liquid containing water may be an aqueous solution. The cooling fluid may possibly include an additive to avoid corrosion and/or improve effluent treatment.

According to one advantageous embodiment of the invention, the production rate of the said droplets or the cooling fluid flow rate is adjusted as a function of measured values and/or determined criteria. For example, the fluid flow may be adjusted retroactively as a function of the temperature of the effluents measured just before they are introduced into the reactor, or more precisely measured at a point T at a determined distance Dm from it (see FIG. 4). In other words, the treatment process according to the invention advantageously includes a measurement of the effluent temperature at at least one point T located at a determined distance Dm from the reactor(s) (12), and an adjustment of the fluid flow rate as a function of the measured temperature. According to one variant of this embodiment, the fluid flow rate may be retroactively adjusted as a function of the temperature measurements of the effluents made just before they are introduced into the reactor(s) (12) and effluent flow rate measurements made typically upstream or downstream of the injection device (30). Effluent temperature measurements upstream of the injection device (30) may possibly be made in order to determine the cooling fluid vaporisation rate.

According to the invention, the installation for treatment of gaseous effluents produced by at least one igneous electrolysis aluminium production cell (1) comprises treatment means (12-19) and a cooling device (29) upstream of the said treatment means.

In one preferred embodiment of the invention, the cooling device (29) comprises at least one injection device (30) capable of injecting cooling fluid droplets into the said effluents upstream of the treatment means (12-19).

More precisely, the installation for treatment of gaseous effluents produced by at least one igneous electrolysis aluminium production cell (1) comprises:
treatment means (12-19) comprising at least:
   a reactor (12) to extract fluorinated products contained in the said effluents by reaction with powder alumina (16);
   a separation device (13) to separate alumina output from the reactor(s) (12) and the residual gas fraction and comprising filtration means (14),
at least one conveyance duct (11) carrying the said effluents to the said treatment means (12-19),
means (23, 24, 25) for conveyance of all or some of the alumina output from the separation device (13), called “fluorinated” alumina, to one or several electrolytic cells (1),

and is characterised in that it also comprises a device (30) for injection of cooling fluid droplets into the conveyance ducts (11) or at least one of the conveyance ducts (11) at at least one point (P) located upstream of the reactor(s) (12).

The reactor(s) (12) and the separation device(s) (13) may be grouped into a single treatment system (19).

Each reactor (12) typically includes means of putting powder alumina into suspension. This variant enables alumina to react efficiently with the gaseous effluents conveyed by the duct(s) (11).

The filtration means (14) of the separation device (13) are typically included in a confinement chamber (15).

Part of the “fluorinated” alumina output from the separation device (13) through the outlet duct(s) (18) may be recycled into the reactor(s) (12) through a branching duct (17).

The conveyance means (23, 24, 25) typically comprise storage means (24) and transport (23) and distribution ducts (25).

The residual gas fraction (in other words the gaseous part of the effluents expurged from the fluorinated products) output from the separation device (13) is usually evacuated through the evacuation means (20, 21, 22). It may possibly be treated by complementary means.

As illustrated in FIG. 3, the device (30) for injection of a cooling fluid into the conveyance duct(s) (11) typically comprises at least one injection means (31) and a cooling fluid source (39). The injection device (30) may include a pump (38). In one embodiment of the invention, the injection means (31) is a pulverisation means such as one or several nozzles. The pulverisation means can form at least one dispersion cone (or sprinkling cone) (40) of the cooling fluid droplets that can be oriented. The injection device (30) may also comprise a filter (36) to stop the particles that could plug the pulverisation means (31). The injection means (31) are advantageously made of a material capable of resisting corrosion or coated by a material capable of resisting corrosion.

According to one variant of the invention, the injection device (30) also comprises a compressed air source (34).

The injection device (30) may also comprise regulation means (33, 37) such as a cooling fluid pressure and/or a flow rate regulator (37). In the variant of the invention in which the injection device (30) comprises a compressed air source (34), the injection device (30) advantageously comprises a compressed air pressure regulator (33). The injection device (30) may also comprise means of measuring the pressure and/or flow rate of the cooling fluid and/or air. These means may be used for regulation or control of the injection device (30). The regulation or control may be used by an operator, a logic controller or a regulation system.

The conveyance duct(s) (11) may comprise an anti-corrosion lining on all or some of their internal wall, particularly close to the droplet injection point(s) (P).

According to one advantageous variant of the invention, the treatment installation comprises a Venturi upstream of the reactor(s) (12) and at least one injection point (P) for the injection of cooling fluid droplets is located in the Venturi. One or several injection points may possibly be located upstream and/or downstream of the Venturi.

According to another advantageous variant of the invention, the treatment installation comprises a regulation system (50) comprising at least one probe (51) for measuring the temperature of effluents upstream of the reactor(s) (12) (and more precisely at a point T located at a determined distance Dm from them) and a control unit (52) for the injection device (30) (see FIG. 4). The control unit (52) typically acts in feedback on the cooling fluid pressure and/or flow rate regulator (37) and/or the compressed air pressure regulator (33), as a function of the measured temperature values. Control is typically done so as to prevent the effluent temperature from exceeding a determined threshold value Tm.

Tests

A cooling test was carried out on electrolytic aluminium production cells using a process and device according to the invention.

The treatment installation was similar to that shown in FIG. 2 and also comprised a Venturi downstream of the water droplet injection point. The injection device included a nozzle activated by compressed air.

The cooling fluid was water at ambient temperature. Cooling water was injected continuously for 3 weeks.

The effluents were taken from three electrolytic cells operating at 495 kA. The effluent flow was about 9 Nm³/s. The temperature of effluents at the reactor inlet was about 150° C. when no cooling fluid was added. Water injection reduced the temperature of the effluents from the cell by at least 8° C. The temperature reduction was as much as 20° C.

The applicant noted that providing the required quantity of cooling water flow rate necessary to significantly lower the effluent temperature only very slightly increased the water content in the effluents. More precisely, a water injection flow of the order of 2.1 l/min, sufficient to lower the effluent temperature by about 8° C., was accompanied by the introduction of about 0.3% by weight of water into the effluent flow, while the water content of the effluents without any water injection was between 0.9 and 1.1% by weight (observed values typically being between 0.1 and 2% by weight depending on the humidity of the ambient air).

The applicant also surprisingly observed that injected water only became very slightly fixed to the alumina during treatment and that emissions of fluorinated products by the electrolytic cell did not increase when the effluents were cooled by water injection. Almost all the water injected into the effluents went into the chimney and the water content of the alumina did not vary significantly.

Performances of the treatment installation were not degraded by the presence of water in the effluents. On average, they were even improved during the period of the tests, and the inventors believe that this was due to the drop in the average temperature of the effluents.

These tests also showed that the alumina attrition rate (in other words the formation of fines by friction) was lower than when there is no injection of cooling water. Starting from an average value of the order of about 10%, the attrition rate dropped to about 5% during the three-week cooling period.

### List of Numeric References

1 Electrolytic cell
2 Pot
3 Anodes
4 Alumina supply device
5 Electrolytic bath
10 Hooding
11 Conveyance duct
12 Reactor
13 Separation device
14 Filters
15 Confinement chamber
16 Fresh alumina source
17 Fluorinated alumina branching duct
18 Fluorinated alumina outlet duct
19 Treatment system
20 Evacuation duct
21 Fan
22 Chimney
23 Fluorinated alumina transport duct
24 Fluorinated alumina storage means
25 Fluorinated alumina distribution duct
29 Cooling device
30 Injection device
31 Injection means
32 Compressed air inlet
33 Compressed air pressure regulator
34 Compressed air source
35 Cooling fluid inlet
36 Filter
37 Cooling fluid pressure and/or flow rate regulator
38 Pump
39 Cooling fluid source
40 Cooling fluid droplets dispersion cone
50 Regulation system
51 Effluent temperature measurement probe
52 Control unit

1. Process for treatment of gaseous effluents produced by at least one igneous electrolysis aluminium production cell (1) comprising:
conveying the said effluents through at least one duct (11) to treatment means (12-19) comprising at least:
a reactor (12) to extract the fluorinated products contained in the effluents by reaction with powder alumina (16);
a separation device (13) to separate alumina output from the reactor(s) (12) and the residual gas fraction and comprising filtration means (14),
introducing effluents and powder alumina into the reactor(s) (12), so that the effluents will react with alumina,
separating alumina from the residual gas fraction using the separation device (13),
conveying all or some of the alumina output from the separation device (13), to one or several electrolytic cells (1),
and characterised in that it further comprises injection of cooling fluid droplets into the conveyance duct (11) or at least one of the conveyance ducts (11) at at least one point (P) located upstream of the reactor(s) (12), so as to cool the effluents by vaporisation of the said fluid before they are introduced into the reactor(s) (12).

2. Treatment process according to claim 1, characterised in that the location of the injection point(s) (P) of the cooling fluid into the conveyance ducts (11) is such that the droplets evaporate entirely before they reach the reactor(s) (12).

3. Treatment process according to claim 1, characterised in that the droplets are injected in the effluent flow direction.

4. Treatment process according to claim 1, characterised in that the cooling fluid droplets are injected in the form of a dispersion cone (40) with an opening angle α lower than about 20°.

5. Treatment process according to claim 1, characterised in that the size of droplets is between 1 μm and 100 μm.

6. Treatment process according to claim 1, characterised in that the said droplets are produced by pulverisation of the said fluid.

7. Treatment process according to claim 1, characterised in that the cooling fluid is water or a liquid containing water.

8. Treatment process according to claim 1, characterised in that it includes a measurement of the effluent temperature at at least one point T located at a determined distance Dm from the reactor(s) (12), and an adjustment of the fluid flow rate as a function of the measured temperature.

9. Treatment process according to claim 1, characterised in that it also comprises heating of the cooling fluid before it is introduced in the conveyance duct(s) (11).

10. Treatment process according to claim 1, characterised in that it also comprises circulation of effluents in a Venturi upstream of the reactor(s) (12) and in that at least some or all of the cooling fluid droplets are injected into the Venturi.

11. Treatment installation for gaseous effluents produced by at least one igneous electrolysis aluminium production cell (1) comprising:
treatment means (12-19) comprising at least:
a reactor (12) to extract fluorinated products contained in the said effluents by reaction with powder alumina (16);
a separation device (13) to separate alumina output from the reactor(s) (12) and the residual gas fraction and comprising filtration means (14),
at least one conveyance duct (11) carrying the said effluents to the said treatment means (12-19),
means (23, 24, 25) for conveyance of all or some of the alumina output from the separation device (13) to one or several electrolytic cells (1),
and characterised in that it further comprises a device (30) for injection of cooling fluid droplets into the conveyance duct (11) or at least one of the conveyance ducts (11) at at least one point (P) located upstream of the reactor(s) (12).

12. Treatment installation according to claim 11, characterised in that each reactor (12) includes means of putting powder alumina (16) into suspension.

13. Treatment installation according to claim 11, characterised in that the location of the injection point(s) (P) of the cooling fluid into the conveyance ducts (11) is such that the droplets evaporate entirely before they reach the reactor(s) (12).

14. Treatment installation according to any claim 11, characterised in that the device (30) for injection of a cooling fluid into the conveyance duct(s) (11) comprises at least one injection means (31) chosen from among pulverisation means.

15. Treatment installation according to claim 14, characterised in that the pulverisation means comprises at least one nozzle.

16. Treatment installation according to any claim 11, characterised in that it comprises a Venturi upstream of the reactor(s) (12) and at least one injection point (P) for injecting cooling fluid droplets is located in the Venturi.

17. Treatment installation according to any claim 11, characterised in that the conveyance duct(s) (11) comprise an anti-corrosion lining on all or some of their internal wall.

18. Treatment installation according to claim 11, characterised in that the injection device (30) further comprises regulation means (33, 37).

19. Treatment installation according to claim 18, characterised in that the regulation means (33, 37) comprise a cooling fluid pressure and/or flow rate regulator (37).

20. Treatment installation according to claim 18, characterised in that it comprises a regulation system (50) comprising at least one probe (51) for measuring the temperature of effluents upstream of the reactor(s) (12) and a control unit (52) for the injection device (30).
